(19) United States
(12) Patent Application Publication
(10) Pub. No.: US 2014/0379780 A1
(43) Pub. Date: Dec. 25, 2014

(54) DETERMINING A SUPPORT PACKAGE STATUS

(71) Applicants: Thorsten Scheyter, Nussloch (DE); Dirk Rosenkranz, Berlin (DE); Sylvia Groth, Rauenberg (DE); Stephan Heidel, Sinsheim (DE); Premchand Nutakki, Heidelberg (DE); Kai Schneider, Leimen (DE)

(72) Inventors: Thorsten Scheyter, Nussloch (DE); Dirk Rosenkranz, Berlin (DE); Sylvia Groth, Rauenberg (DE); Stephan Heidel, Sinsheim (DE); Premchand Nutakki, Heidelberg (DE); Kai Schneider, Leimen (DE)

(73) Assignee: SAP AG, Walldorf (DE)

(21) Appl. No.: 13/926,409

(22) Filed: Jun. 25, 2013

(51) Int. Cl. H04L 29/08

(52) U.S. Cl. CPC H04L 67/10
USPC 709/203

(57) ABSTRACT

Techniques for obtaining a support package status associated with a software component executing on a computing system include receiving a transport request that comprises metadata associated with a software component, and a support package start point that defines an updated support package status of the software component for receiving an updated support package for the software component; in response to receiving the transport request, creating a correction transport that comprises the support package start point and metadata associated with the updated support package; distributing the correction transport to a computing system; in response to distributing the correction transport, identifying a current support package status of the software component; comparing the current support package status of the software component with the updated support package status of the support package start point; and based on the comparison, updating the support package status of the software component.

### TECHNICAL BACKGROUND

This disclosure relates to obtaining a support package status associated with a software component executing on a computing system in a distributed computing environment.

### BACKGROUND

When setting up a maintenance system/landscape to provide a support package of a software component, the information about the current support package status is not stored in the systems of the landscape. This is due to that instead of importing corrections through final support packages, the corrections are transported as increments of these final support packages to the subsequent systems, or are performed directly in the correction systems.

Furthermore, all corrections from several subsequent support packages of the software component may have already been imported into the system, but the transport-based supply does not reflect this information in the system status. Due to this, many developers have trouble identifying the current maintenance (or future support package) level for which the corrections are done. Inexperienced system administrators might even install an in-correct support package accidently in such a system. This could result in several conflicts and cause undesired effects in the system or might even make the system unstable and/or unusable, including possible recovery of a previous system state.

### SUMMARY

The present disclosure relates to computer-implemented methods, software, and systems for obtaining a support package status associated with a software component executing on a computing system in a distributed computing environment. In some implementations, a transport request is received that includes metadata associated with a software component, and further includes a support package start point. The support package start point defines an updated support package status of the software component for receiving an updated support package for the software component. In response to receiving the transport request, a correction transport is created. The correction transport includes the support package start point and metadata associated with the updated support package. The correction transport, including the support package start point, is distributed to a computing system in the distributed computing system landscape. The computing system includes the software component. In response to distributing the correction transport, a current support package status of the software component that is executing on the computing system is identified. The current support package status of the software component is compared with the updated support package status of the support package start point. Based on the comparison, the support package status of the software component is updated.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

In a first aspect combinable with any of the general implementations, creating the correction transport further includes adding the correction transport to a buffer.

In a second aspect combinable with any of the previous aspects, distributing the correction transport further includes distributing the correction transport from the buffer to the computing system.

In a third aspect combinable with any of the previous aspects, distributing the correction transport further includes asynchronously distributing the correction transport to a plurality of computing systems in the distributing computing landscape and each computing system includes the software component. \

A fourth aspect combinable with any of the previous aspects further includes identifying a maintenance mode associated with the software component and the maintenance mode includes a transport maintenance mode and a final maintenance mode.

A fifth aspect combinable with any of the previous aspects further includes distributing the correction transport to the computing system based on the transport maintenance mode being associated with the software component.

A sixth aspect combinable with any of the previous aspects further includes distributing the updated support package to the computing system based on the final maintenance mode being associated with the software component.

A seventh aspect combinable with any of the previous aspects further includes, based on the final maintenance mode being associated with the software component, preventing distribution of the correction transport to the computing system.

An eighth aspect combinable with any of the previous aspects further includes, based on the transport maintenance mode being associated with the software component, preventing distribution of the updated support package to the computing system.

In a ninth aspect combinable with any of the previous aspects, the software component is associated with one or more software sub-components.

A tenth aspect combinable with any of the previous aspects further includes receiving, for each software sub-component, a transport request that includes metadata associated with the software sub-component, and a support package start point.

In an eleventh aspect combinable with any of the previous aspects further includes, in response to receiving each transport request, creating a correction transport that includes the support package start point and metadata associated with the updated support package.

A twelfth aspect combinable with any of the previous aspects further includes distributing each of the correction transports to a computing system in the distributed computing system landscape.

In a thirteenth aspect combinable with any of the previous aspects, the computing system includes the software sub-components.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

Various implementations of a computing system according to the present disclosure may have one or more of the following features. For example, such features include determining the correct support package status associated with a software component, and display of such to an end user; and testing of various functionalities (e.g., import conditions) associated with the support package.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example distributed computing system for obtaining a support package status associated with a software component executing on a computing system in a distributed computing environment;

FIG. 2 illustrates a system for identifying a system status of one or more computing systems in a distributed computing system landscape;

FIG. 3 is a swim lane diagram that illustrates a method for the creation of a correction transport;

FIG. 4 is a swim lane diagram that illustrates a method for the distribution of the correction transport;

FIGS. 5A and 5B illustrate a table including information associated with the software component;

FIG. 6A illustrates a maintenance mode selection system;

FIG. 6B illustrates multiple software components each associated with a particular maintenance mode;

FIG. 7 is a flow chart that illustrates a method for obtaining a support package status in a distributed computing system landscape;

FIG. 8 is a flow chart that illustrates a method for determining a maintenance mode of the computing system in a distributed computing system landscape; and

FIG. 9 is a flow chart that illustrates a method for obtaining a support package status for multiple software modules in a distributed computing system landscape.

### DETAILED DESCRIPTION

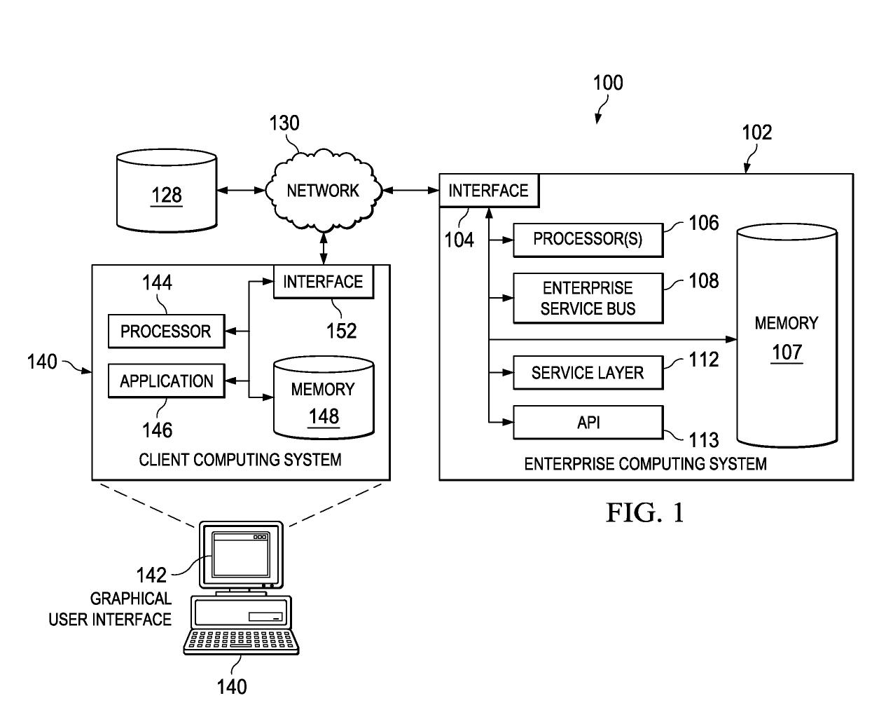

FIG. 1 illustrates an example distributed computing system 100 for obtaining a support package status associated with a software component executing on a computing system in a distributed computing environment. In some implementations, a transport request is received that includes metadata associated with a software component, and further includes a support package start point. The support package start point defines an updated support package status of the software component for receiving an updated support package for the software component. In response to receiving the transport request, a correction transport is created. The correction transport includes the support package start point and metadata associated with the updated support package. The correction transport, including the support package start point, is distributed to a computing system in the distributed computing system landscape. The computing system includes the software component. In response to distributing the correction transport, a current support package status of the software component that is executing on the computing system is identified. The current support package status of the software component is compared with the updated support package status of the support package start point. Based on the comparison, the support package status of the software component is updated.

In some examples, the illustrated enterprise server computing system 102 may store a plurality of various hosted applications, while in some examples, the enterprise server computing system 102 may be a dedicated server meant to store and execute only a single hosted application. In some instances, the enterprise server computing system 102 may comprise a web server, where the hosted applications represent one or more web-based applications accessed and executed via the network 130 by the client computing system 140 to perform the programmed tasks or operations of the hosted application.

At a high level, the illustrated enterprise server computing system 102 comprises an electronic computing device operable to receive, transmit, process, store, or manage data and information associated with the distributed computing system 100. Specifically, the enterprise server computing system 102 illustrated in FIG. 1 is responsible for receiving application requests from one or more client applications associated with the client computing system 140 of the distributed computing system 100 and responding to the received requests by processing said requests in the associated hosted application, and sending the appropriate response from the hosted application back to the requesting client application. In addition to requests from the client computing system 140 illustrated in FIG. 1, requests associated with the hosted applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise server computing system 102, the distributed computing system 100 can be implemented using two or more servers, as well as computers other than servers, including a server pool. In some examples, the enterprise server computing system 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the enterprise server computing system 102 may be adapted to execute any operating system, including Linux, UNIX, Windows, Mac OS, or any other suitable operating system.

The illustrated enterprise server computing system 102 further includes an interface 104. Although illustrated as a single interface 104 in FIG. 1, two or more interfaces 104 may be used according to particular needs, desires, or particular implementations of the example distributed computing system 100. The interface 104 is used by the enterprise server computing system 102 for communicating with other systems in a distributed environment—including within the example distributed computing system 100—connected to the network 130; for example, the client computing system 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, ABAP, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The illustrated enterprise server computing system 102 further includes a processor 106. Although illustrated as a single processor 106 in FIG. 1, two or more processors may be used according to particular needs, desires, or particular implementations of the example distributed computing system 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise server computing system 102. Specifically, the processor 106 executes the functionality required to receive and respond to requests from the client computing system 140.

The illustrated enterprise server computing system 102 also includes a memory 107. Although illustrated as a single memory 107 in FIG. 1, two or more memories may be used according to particular needs, desires, or particular implementations of the example distributed computing system 100. While memory 107 is illustrated as an integral component of the enterprise server computing system 102, in some implementations, the memory 107 can be external to the enterprise server computing system 102 and/or the example distributed computing system 100. The memory 107 may include any memory or database module and may take the form of volatile or non-volatile memory including, without limitation, magnetic media, optical media, random access memory (RAM), read-only memory (ROM), removable media, or any other suitable local or remote memory component. The memory 107 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise computing system 102. Additionally, the memory 107 may include any other appropriate data, such as VPN applications, firmware logs and policies, firewall policies, a security or access log, print or other reporting files, as well as others.

The illustrated enterprise server computing system 102 further includes a service layer 112. The service layer 112 provides software services to the example distributed computing system 100. The functionality of the enterprise server computing system 102 may be accessible for all service consumers using this service layer. Software services provide reusable, defined business functionalities through a defined interface. For example, the interface may be software written in extensible markup language (XML) or other suitable language. While illustrated as an integrated component of the enterprise server computing system 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module, enterprise application, or hardware module without departing from the scope of this disclosure.

The illustrated enterprise server computing system 102 further includes an application programming interface (API) 113. In some implementations, the API 113 can be used to interface between the design engine 118 and one or more components of the enterprise server computing system 102 or other components of the example distributed computing system 100, both hardware and software. For example, in some implementations, the design engine 118 can utilize the API 113 to communicate with the client computing system 140. The API 113 may include specifications for routines, data structures, and object classes. The API 113 may be either computer language independent or dependent and refer to a complete interface, a single function, or even a set of APIs. While illustrated as an integrated component of the enterprise server computing system 102 in the example distributed computing system 100, alternative implementations may illustrate the API 113 as a stand-alone component in relation to other components of the example distributed computing system 100. Moreover, any or all parts of the API 113 may be implemented as child or sub-modules of another software module, enterprise application, or hardware module without departing from the scope of this disclosure.

The client computing system 140 may be any computing device operable to connect to or communicate with at least the enterprise server computing system 102 using the network 130. In general, the client computing system 140 comprises a computer operable to receive, transmit, process, and store any appropriate data associated with the example distributed computing system 100. The illustrated client computing system 140 further includes an application 146. The application 146 is any type of application that allows the client computing system 140 to request and view content on the client computing system 140. In some implementations, the application 146 can be and/or include a web browser. In some implementations, the application 146 can use parameters, metadata, and other information received at launch to access a particular set of data from the enterprise server computing system 102. Once a particular application 146 is launched, a user may interactively process a task, event, or other information associated with the enterprise server computing system 102. Further, although illustrated as a single application 146, the application 146 may be implemented as multiple applications in the client computing system 140.

The illustrated client computing system 140 further includes an interface 152, a processor 144, and a memory 148. The interface 152 is used by the client computing system 140 for communicating with other systems in a distributed environment—including within the example distributed computing system 100—connected to the network 130; for example, the enterprise server computing system 102 as well as other systems communicably coupled to the network 130 (not illustrated). The interface 152 may also be consistent with the above-described interface 104 of the enterprise server computing system 102 or other interfaces within the example distributed computing system 100.

The processor 144 may be consistent with the above-described processor 106 of the enterprise server computing system 102 or other processors within the example distributed computing system 100. Specifically, the processor 144 executes instructions and manipulates data to perform the operations of the client computing system 140, including the functionality required to send requests to the enterprise server computing system 102 and to receive and process responses from the enterprise server computing system 102. The memory 148 may be consistent with the above-described memory 107 of the enterprise server computing system 102 or other memories within the example distributed computing system 100 but storing objects and/or data associated with the purposes of the client computing system 140.

Further, the illustrated client computing system 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the enterprise server computing system 102. Generally, through the GUI 142, an enterprise server computing system 102 user is provided with an efficient and user-friendly presentation of data provided by or communicated within the example distributed computing system 100.

There may be any number of client computing systems 140 associated with, or external to, the example distributed computing system 100. For example, while the illustrated example distributed computing system 100 includes one client computing system 140 communicably coupled to the enterprise server computing system 102 using network 130, alternative implementations of the example distributed computing system 100 may include any number of client computing systems 140 suitable for the purposes of the example distributed computing system 100. Additionally, there may also be one or more client computing systems 140 external to the illustrated portion of the example distributed computing system 100 that are capable of interacting with the example distributed computing system 100 using the network 130. Moreover, while the client computing system 140 is described in terms of being used by a single user, this disclosure contemplates that many users may use one computer, or that one user may use multiple computers.

The illustrated client computing system 140 is intended to encompass any computing device such as a desktop computer, laptop/notebook computer, wireless data port, smart phone, personal data assistant (PDA), tablet computing device, one or more processors within these devices, or any other suitable processing device. For example, the client computing system 140 may comprise a computer that includes an input device, such as a keypad, touch screen, or other device that can accept user information, and an output device that conveys information associated with the operation of the enterprise server computing system 102 or the client computing system 140 itself, including digital data, visual information, or a GUI 142, as shown with respect to the client computing system 140.

The illustrated distributed computing system 100 further includes a repository 128. In some implementations, the repository 128 is an in-memory repository. The repository 128 can be a cloud-based storage medium. For example, the repository 128 can be networked online storage where data is stored on virtualized pools of storage.

With respect to the network 130, generally, the illustrated network 130 facilitates wireless or wireline communications between the components of the distributed computing system 100 (i.e., between the computing systems 102 and 140), as well as with any other local or remote computer, such as additional clients, servers, or other devices communicably coupled to network 130 but not illustrated in FIG. 1. The network 130 is illustrated as a single network in FIG. 1, but may be a continuous or discontinuous network without departing from the scope of this disclosure, so long as at least a portion of the network 130 may facilitate communications between senders and recipients. The network 130 may be all or a portion of an enterprise or secured network, while in another instance at least a portion of the network 130 may represent a connection to the Internet.

In some instances, a portion of the network 130 may be a virtual private network (VPN), such as, for example, the connection between the client computing system 140 and the enterprise server computing system 102. Further, all or a portion of the network 130 can comprise either a wireline or wireless link. Example wireless links may include 802.11a/b/g/n, 802.20, WiMax, and/or any other appropriate wireless link. In other words, the network 130 encompasses any internal or external network, networks, sub-network, or combination thereof operable to facilitate communications between various computing components inside and outside the illustrated distributed computing system 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

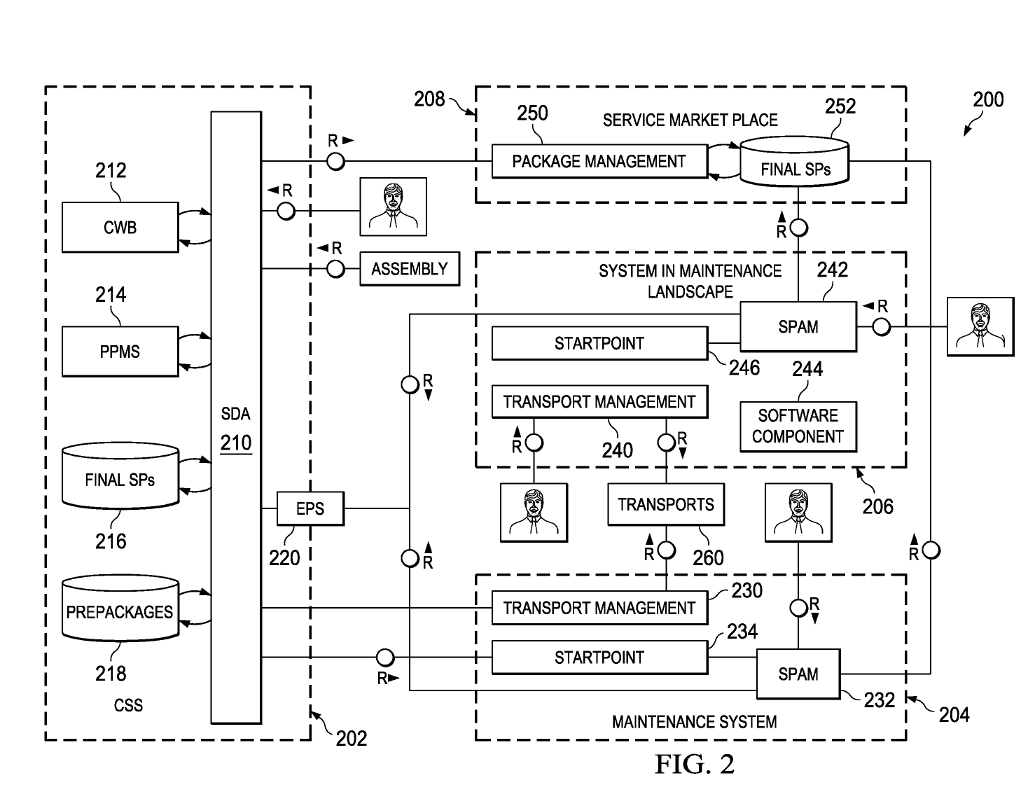

FIG. 2 illustrates a system 200 for identifying a system status of one or more computing systems in a distributed computing system landscape. System 200 includes a customer service system (CSS) 202, a maintenance system 204, a computing system 206, and a service marketplace system 208. For simplicity of illustration, the system 200 is shown including a single computing system 206; however, system 200 can include any number of computing systems. Additionally, system 200 can be implemented by the enterprise computing system 102, the client computing system 140, or a combination thereof. For example, the CSS 202, the maintenance system 204, and the service marketplace system 208 are implemented by the enterprise computing system 102 and the computing system 206 is implemented by the client computing system 140. In some examples, each of the CSS 202, the maintenance system 204, the computing system 206, and the service marketplace system 208 are implemented by the enterprise computing system 102. In some examples, the service marketplace system 208 is implemented by a third-party computing system (e.g., an external software product provider).

In some implementations, the CSS 202 includes a software delivery assembler (SDA) 210, a correction work bench (CWB) 212, a product and production management system (PPMS) 214, a final support package (SP) repository 216, a prepackages repository 218, and an electronic parcel service (EPS) 220. In some examples, the CWB 212 is an administrative tool to control, configure, observer, and verify corrections for objects of the system 200; the PPMS 214 is a central database and knowledge base for information for components of the system 200 (e.g., developing and delivering software products); and the EPS 220 is a download support tool. The CSS 202 is in communication with the maintenance system 204, the computing system 206, and the service marketplace system 208. In general, the CSS 202 registers and assembles support packages, and provides transport requests to the maintenance system 204 including support package start points, described further below.

The maintenance system 204 includes a transport management module 230 and a support package manager (SPAM) 232. The maintenance system 204 is in communication with the CSS 202, the computing system 206, and the service marketplace system 208. In general, the maintenance system 204 receives a request from the CSS 202 via a remote communication channel that includes meta data of a support package start point. This request triggers the creation of the support package start point in the maintenance system 204 and triggers also the creation of a correction transport that includes the support package start point, and distributes the correction transport to the computing system 206, described further below.

The computing system 206 includes a transport management module 240, a support package manager (SPAM) 242, a software component 244, and a start point module 246. For simplicity of illustration, the computing system 206 is shown including one software component 244; however, the computing 206 can include multiple software components. The computing system 206 is in communication with the CSS 202, the maintenance system 204, and the service marketplace system 208. In general, the computing system 206 receives the correction transport from the maintenance system 204, and evaluates all existing support package start points and installed support packages to determine the support package status of the software components.

The service marketplace system 208 includes a package management module 250 and a final support package repository 252. The service marketplace system 208 is in communication with the CSS 202, the maintenance system 204, and the computing system 206. In general, the service marketplace system 208 provides support packages to the computing system 206, described further below.

To that end, the system 200 identifies a support package status associated with the software component 244. Particularly, in some implementations, the maintenance system 204 receives a request from the CSS 202, specifically from the SDA 210 of the CSS 202. The request includes, at least, metadata associated with the software component 244, and the support package start point 234. The support package start point 234 defines an updated support package status of the software component 244 for receiving an updated support package for the software component 244.

Specifically, in some examples, the software component 244 can be associated with (e.g., includes) a support package and further a support package status. In some examples, the support package status can include a current level of the support package (e.g., revision level or release level) associated with the software component 244, a source of the support package (e.g., the SDA 210 or the service marketplace system 208), or other identifying information. To that end, an updated support package can include one or more prerequisite conditions such that the updated support package can become associated with the software component 244 (e.g., installation of the updated support package on the computing system 206). For example, the updated support package can require a minimum current support package status such that the updated support package can become associated with the software component 244. For example, for the updated support package level of n, for association of the updated support package with the software component 244, the current status level of the current support package associated with the software component 244 is n−1 (e.g., the immediate previous support package status level).

In some examples, the support package start point 234 includes, at least, the support package start point and metadata associated with the updated support package. The support package start point 234 corresponds to the software component 244.

In some implementations, in response to receiving the support package start point 234, the maintenance system 204 creates a correction transport. The correction transport includes data that is associated with the support package start point 234, or includes the support package start point 234. In some examples, creating the correction transport further includes the maintenance system 204 adding the correction transport to a buffer (not shown) that is included by the transport management module 230.

In some implementations, the maintenance system 204 distributes the correction transport to the computing system 206. Particularly, the transport management module 230 of the maintenance system 204 distributes transports 260, including the correction transport, to the transport management module 240 of the computing system 206. In some examples, the maintenance system 204 distributes the correction transport (e.g., via transports 260) to the computing system 206 from a buffer (not shown). In some examples, when the system 200 includes multiple computing systems 206, the support package start point is distributed asynchronously to two or more of the multiple computing systems 206 (e.g., via the correction transport).

In some examples, in response to receiving the correction transport from the maintenance system 204, a start point module 246 processes the support package start point of the correction transport. The start point module 246 is in communication with the SPAM 242. Thus, the start point module 246 can provide the current support package status of the support package that corresponds to the software component 244. For example, the start point module 246 can provide such information to the SPAM 242 prior to an attempt of receiving the updated support package by the SPAM 242 from either the SDA 210 or the service marketplace 208. For example, the start point module 246 can include or be associated with a database table that reflects the current support package status of the support package that corresponds to the software component 244. For example, the current support package status can indicate that the maintenance of the support package n is finished and the maintenance of the support package n+1 has started.

In some implementations, the start point module 246 compares the current support package status of the support package that corresponds to the software component 244 with the updated support package status of the support package start point. Specifically, the start point module 246 compares the current support package status of the support package that corresponds to the software component 244 (e.g., the status level) with the updated support package status of the support package start point (e.g., the prerequisite conditions for association of the updated support package with the software component 244). For example, the support package start point includes the support package start point that is associated with the updated support package for the software component 244.

In some examples, comparing the current support package status of the support package that corresponds to the software component 244 with the updated support package status of the support package start point includes comparing a current status level (e.g., revision level or release level). In some examples, comparing the current support package status of the support package that corresponds to the software component 244 with the updated support package status of the support package start point includes matching the current status support package status of the support package the corresponds to the software component 244 with the updated support package status of the support package start point (e.g., both of the same revision level or release level). In some examples, comparing the current support package status of the support package that corresponds to the software component 244 with the updated support package status of the support package start point includes determining that the current support package status of the support package that corresponds to the software component 244 meets (or exceeds) the prerequisite conditions of the updated support package status of the support package start point (e.g., the revision level or release level of the current support package status of the support package that corresponds to the software component 244 meets or exceeds the revision level or release level condition of the updated support package status of the support package start point).

In some implementations, based on the comparison of the current support package status of the support package that corresponds to the software component 244 with the updated support package status of the support package start point, the support package status of the software component 144 is updated. In some examples, the support package status of the software component 144 is updated based on the current support package status of the support package that corresponds to the software component 244 matching the updated support package status of the support package start point (e.g., both of the same revision level or release level). In some examples, the support package status of the software component 144 is updated based on the current support package status of the support package that corresponds to the software component 244 meeting (or exceeding) the prerequisite conditions of the updated support package status of the support package start point (e.g., the revision level or release level of the current support package status of the support package that corresponds to the software component 244 meets or exceeds the revision level or release level condition of the updated support package status of the support package start point).

In some further implementations, the current support package status of the software component 244 that is executing on the computing system 206 is prepared for display. For example, the current support package status of the software component 244 is displayed on a graphical user interface (e.g., the GUI 142). In some examples, the display of the current support status of the software component 244 can be displayed in a table-format. In some examples, when the system 200 includes multiple computing systems 206, the current support package of the software component 244 of two or more of the multiple computing systems 206 are displayed on a GUI. In some examples, the current support package status of the software component 244 is displayed on a GUI that is viewed by (e.g., associated with) an administrator (e.g., IT administrator) of the system 200, or a developer of the software component 244.

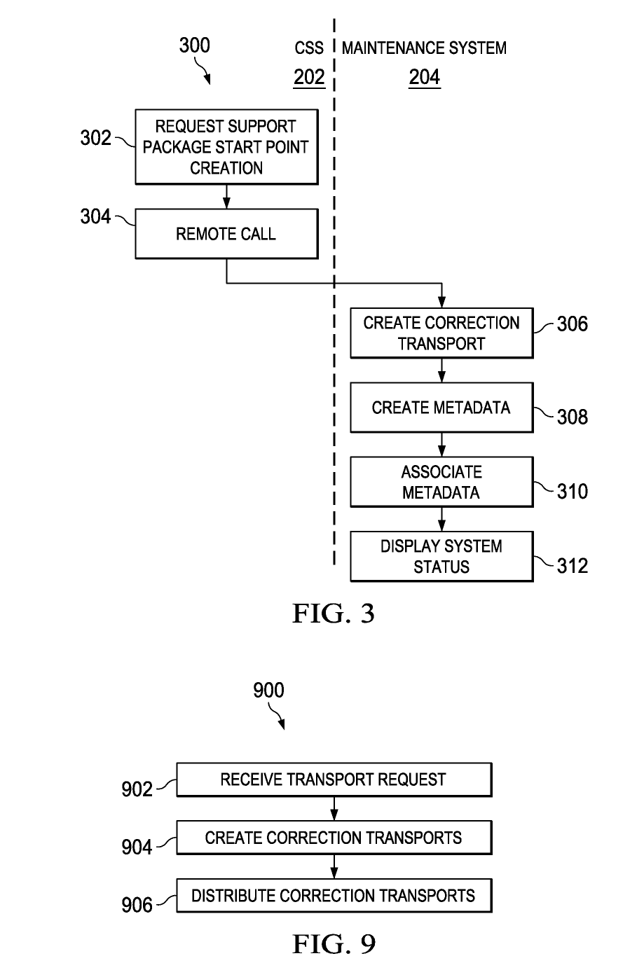

FIG. 3 illustrates a method 300 (e.g., a swim lane diagram) illustrating actions of the CSS 202 and the maintenance system 204 in the creation of the correction transport. For clarity of presentation, the description that follows generally describes method 300 in the context of FIGS. 1 and 2. For example, as illustrated, particular steps of the method 300 may be performed on or at an enterprise system, cloud-based system, and/or on-demand system, while other particular steps may be performed on or at a client system or on-premise system. However, method 300 may be performed, for example, by any other suitable system, environment, software, and hardware, or a combination of systems, environments, software, and hardware as appropriate.

In step 302, the CSS 202 creates the support package start point creation request. Specifically, the request includes, at least, metadata associated with the software component 244, and a support package start point. In step 304, a call is made from the CSS 202 to the maintenance system 204. The call includes the request that includes the support package start point. In step 306, the maintenance system 204 creates the correction transport. In step 308, metadata is created that is associated with the support package start point. In step 310, the created metadata is associated with the correction transport. For example, the metadata is “written” to the correction transport. In step 312, the maintenance system 204 displays the system status.

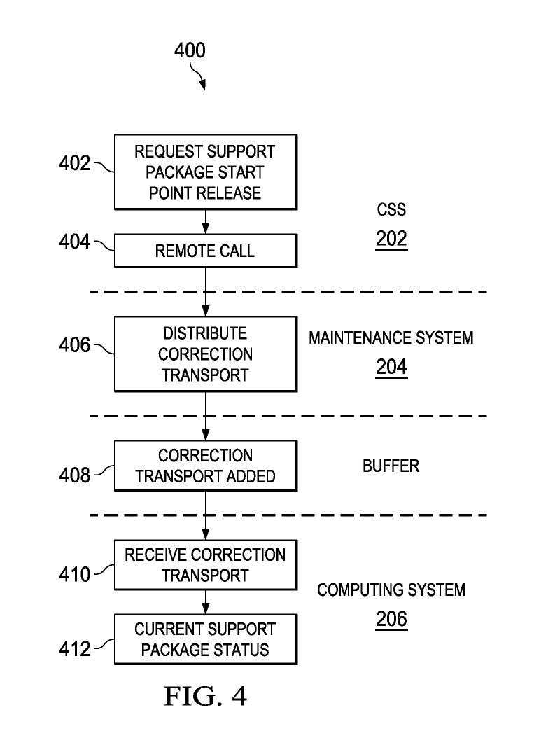

FIG. 4 illustrates a method 400 (e.g., a swim lane diagram) illustrating actions of the CSS 202, the maintenance system 204, and the computing system 206 in the distribution of the correction transport. For clarity of presentation, the description that follows generally describes method 400 in the context of FIGS. 1 and 2. For example, as illustrated, particular steps of the method 400 may be performed on or at an enterprise system, cloud-based system, and/or on-demand system, while other particular steps may be performed on or at a client system or on-premise system. However, method 400 may be performed, for example, by any other suitable system, environment, software, and hardware, or a combination of systems, environments, software, and hardware as appropriate.

In step 402, a user or computing agent triggers the release of a support package start point in CSS 202. In step 404, a call is made from the CSS 202 to the maintenances system 204. In step 406, the maintenance system 204 distributes the correction transport. For example, the maintenance system 204 releases the transport request. In some examples, when the system 200 includes multiple computing systems 206, the correction transport is distributed asynchronously to two or more of the multiple computing systems 206. In step 408, the correction transport is added to the buffer. For example, the maintenance system 204 adds the correction transport to the buffer. In step 410, the computing system 206 receives the correction transport from the buffer. In step 412, the current support package status of the software component 244 that is executing on the computing system 206 is prepared for display.

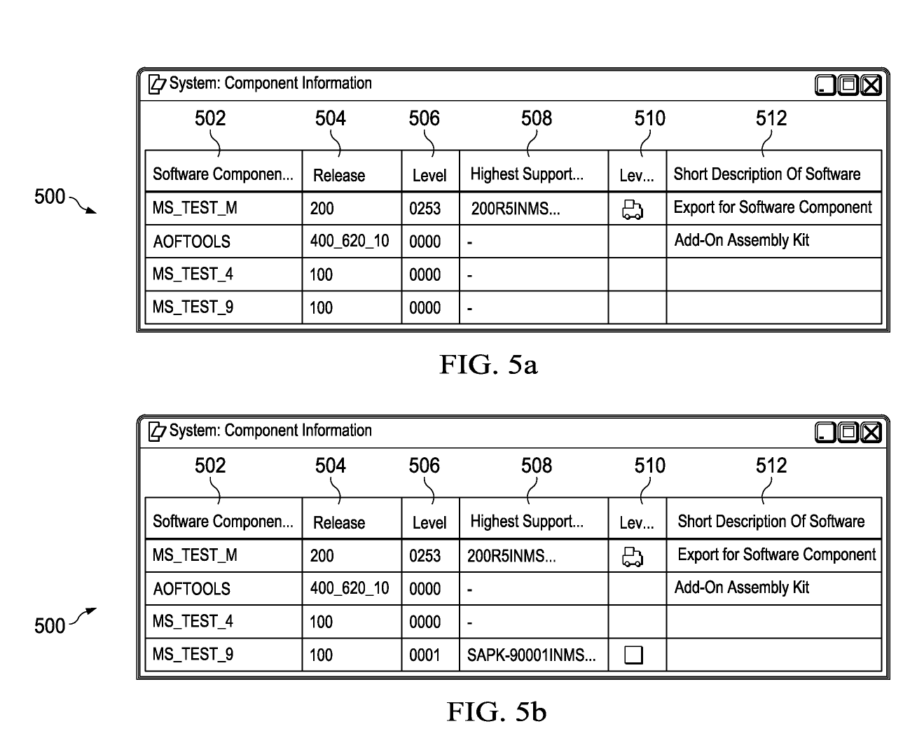

FIGS. 5A and 5B illustrates a table 500 including information associated with the software component 244 (and other software components executing on the computing system 206). Specifically, table 500 includes, for each software component (e.g., the software component 244), a software component name 502, a release status 504, a support package level 506, a highest support indication 508, a short description 510, and a description 512 of the software component.

To that end, FIG. 5A illustrate the table 500 prior to distributing of the updated support package to the computing system 206. For example, for the software component name 502 “MS_TEST_{—}9,” the current status level 506 is “0000.” FIG. 5B illustrates the table 500 after distributing the updated support package to the computing system 206. For example, for the software component name 502 “MS_TEST_{—}9,” the current status level 506 is “0001.” Further, the table 500 also indicates, after distribution of the updated support package to the computing system 206, that the highest support indication 508 includes an updated support level. Additionally, the table 500 further indicates that the software component name 502 “MS_TEST_M” has received a correction transport and has received a support package start point.

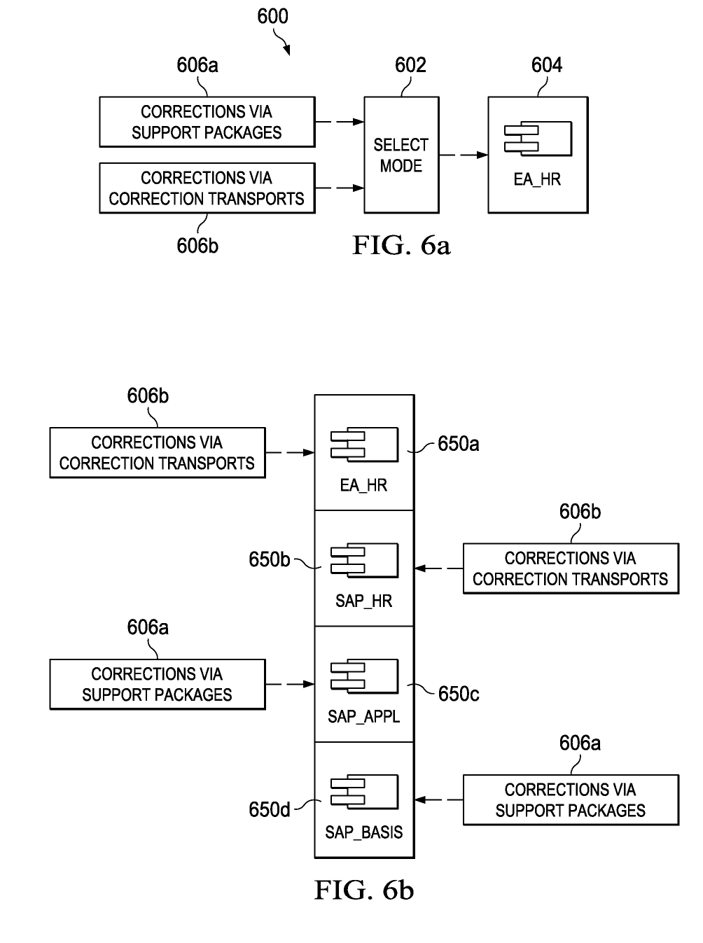

FIG. 6A illustrates a maintenance mode selection system 600. Specifically, in some further implementations, the support package start point (e.g., the correction transport) and the updated support package can be distributed utilizing the maintenance mode selection system 600. The maintenance mode selection system 600 includes a selection mode module 602, a software component 604 (e.g., the software component 244 of the computing system 206), and correction packages 606a, 606b.

Specifically, a maintenance mode is identified that is associated with the software component 604. The maintenance mode includes a transport maintenance mode and a final maintenance mode. In some examples, the selection mode module 602 identifies the maintenance mode. For example, a user (e.g., an IT administrator or software developer) can select, via the selection module 602, the maintenance mode. In some examples, the correction transport is distributed by the maintenance system 204 to the computing system 206 (e.g., the maintenance system 204 distributes the correction transport via the transports 260) when then transport maintenance mode (e.g., “corrections via transport”) is associated with the software component 604 (e.g., the correction transport 606b). Further, in some examples, the updated support package is distributed to the software component 604 (e.g., from the CSS 202, the service marketplace module 208, or both) when the final maintenance mode (e.g., corrections via support packages) is associated with the software component 604 (e.g., the support package 606a).

In some further implementations, when the transport maintenance mode is associated with the software component 604, the distribution of the updated support package is prevented. Moreover, in some further implementations, when the final maintenance mode is associated with the software component, the distribution of the correction transport is prevented.

FIG. 6B illustrates multiple software components 650a, 650b, 650c, 650d each associated with a particular maintenance mode. Specifically, in some examples, the software components 650a, 650b, 650c, 650d are executing on a single computing system (e.g., the computing system 206). The software components 650a and 650b are associated with the transport maintenance mode, and thus receive respective correction transports 606b. The software components 650c and 650d are associated with the final maintenance mode, and thus receive the respective support packages 606a.

In a use-case example, a support package having a support package status level of 3 for a software component has been “reserved” by the CSS 202. A transport request includes metadata associated with the software component, and a support package start point. A start point module is created in the maintenance system and later distributed from the maintenance system to the computing system(s) in the distributed computing system landscape. The updated support package status of the support package start point indicates a status level of 2 is required for the updated support package having a status level of 3 to be installed on the computing system. Thus, the software component is able to receive the updated support package.

In a further use-case example, a support package having a support package status level of 4 is supplied for a particular software component. The IT administrator sets the maintenance mode from transport maintenance mode to the final maintenance mode. Before any new support packages are applied (e.g., the support package having a support package status level of 5), the support package having a support package status level of 4 is to be imported.

In some further implementations, a software master component (e.g., the software component 244) is associated with one or more software sub-components. In some examples, the software master component is associated with multiple software sub-components, but each software sub-component is associated with only one software master component. To that end, for each software sub-component, a transport request is received that includes metadata associated with the software sub-component, and a support package start point. For example, the maintenance system 204 receives the transport request from the CSS 202 for each software sub-component of the software component 244.

In response to receiving each transport request, the maintenance system 204 creates a correction transport for each respective transport request (e.g., each software sub-component). The correction transport includes, at least, the support package start point and metadata associated with the updated support package. Each of the correction transports are distributed to the computing system 206 that include the software sub-components. Specifically, the maintenance system 204, as mentioned above, creates the correction transport. The maintenance system 204 distributes the correction transport, of each software sub-component, to the computing system 206.

In a use-case example, a software component A is a master-component and software components B and C are sub-components of the software component A. Correction transports are created for each of software components B and C, and are distributed asynchronously.

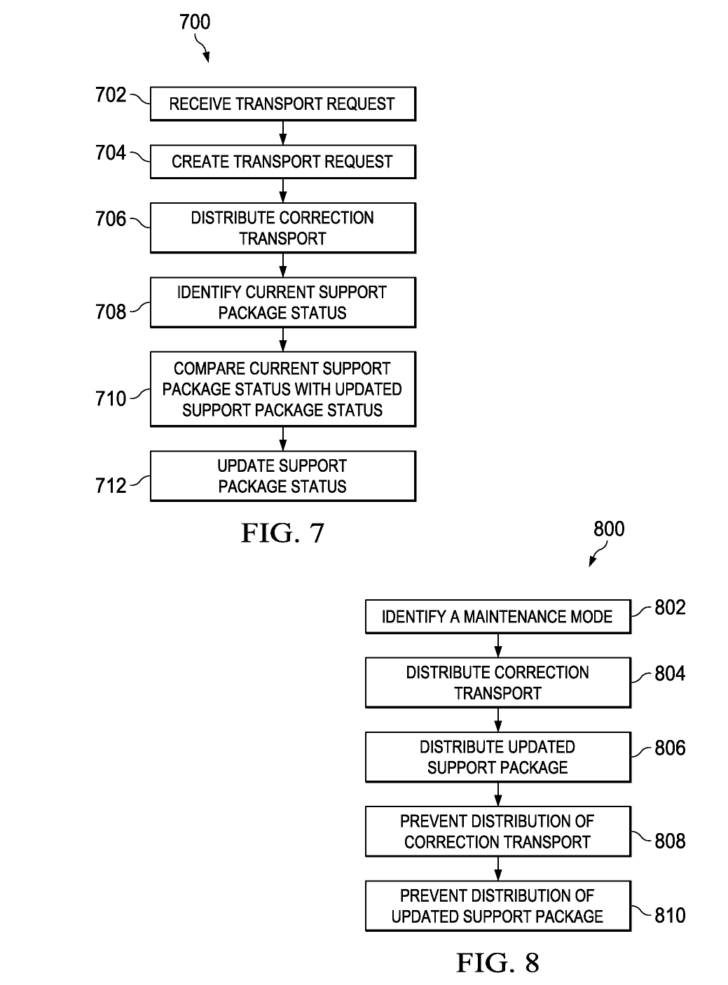

FIG. 7 is a flow chart that illustrates a method 700 for obtaining a support package status in a distributed computing system landscape. For clarity of presentation, the description that follows generally describes method 700 in the context of FIGS. 1 and 2. For example, as illustrated, particular steps of the method 700 may be performed on or at an enterprise system, cloud-based system, and/or on-demand system, while other particular steps may be performed on or at a client system or on-premise system. However, method 700 may be performed, for example, by any other suitable system, environment, software, and hardware, or a combination of systems, environments, software, and hardware as appropriate.

In step 702, a transport request is received that includes metadata associated with a software component, and a support package start point that defines an updated support package status of the software component for receiving an updated support package for the software component. For example, the maintenance system 204 receives the transport request that includes metadata associated with the software component 244, and a support package start point that defines an updated support package status of the software component 244 for receiving an updated support package for the software component 244.

In step 704, in response to receiving the transport request, a correction transport is created that includes the support package start point and metadata associated with the updated support package. For example, the maintenance system 204 creates the correction transport that includes the support package start point and metadata associated with the updated support package. In some examples, creating the correction transport includes associating the metadata associated with the updated support package with the correction transport. In some examples, creating the correction transport includes adding the correction transport to a buffer.

In step 706, the correction transport is distributed to a computing system in the distributed computing system landscape, the computing system including the software component. For example, the correction transport is distributed to the computing system 206. In some examples, distributing the correction transport includes distributing the correction transport from the buffer to the computing system 206. In some examples, when the system 200 includes multiple computing systems 206, the correction transport is asynchronously distributed to the computing systems 206.

In step 708, in response to distributing the correction transport, a current support package status of the software component that is executing on the computing system is identified. For example, the computing system 206 identifies the current support package of the software component 244.

In step 710, the current support package status of the software component is compared with the updated support package status of the support package start point. For example, the current support package status of the software component 244 is compared with the updated support package status of the support package start point.

In step 712, based on the comparison, the support package status of the software component is updated. For example, based on the comparison, the support package status of the software component 244 is updated.

FIG. 8 is a flow chart that illustrates a method 800 for determining a maintenance mode of the computing system in a distributed computing system landscape. For clarity of presentation, the description that follows generally describes method 800 in the context of FIGS. 1 and 2. For example, as illustrated, particular steps of the method 800 may be performed on or at an enterprise system, cloud-based system, and/or on-demand system, while other particular steps may be performed on or at a client system or on-premise system. However, method 800 may be performed, for example, by any other suitable system, environment, software, and hardware, or a combination of systems, environments, software, and hardware as appropriate.

In step 802, a maintenance mode associated with the software component is identified. The maintenance mode includes a transport maintenance mode (e.g., “corrections via transport”) and a final maintenance mode (e.g., corrections via support packages). For example, the maintenance mode module 602 identifies a maintenance mode associated with the software component 604.

In step 804, the correction transport is distributed to the computing system based on the transport maintenance mode being associated with the software component. For example, the maintenance mode selection system 600 distributes the correction transport 606b to the computing system (e.g., the computing system 206) based on the transport maintenance mode being associated with the software component 604.

In step 806, the updated support package is distributed to the computing system based on the final maintenance mode being associated with the software component. For example, the maintenance mode selection system 600 distributes the support package 606a to the computing system (e.g., the computing system 206) based on the final maintenance mode being associated with the software component 604.

In step 808, based on the final maintenance mode being associated with the software component, distribution of the correction transport to the computing system is prevented. For example, the maintenance mode selection system 600 prevents distribution of the correction transport 606b to the computing system (e.g., the computing system 206) based on the final maintenance mode being associated with the software component 604.

In step 810, based on the transport maintenance mode being associated with the software component, distribution of the updated support package to the computing system is prevented. For example, the maintenance mode selection system 600 prevents distribution of the support package 606a to the computing system (e.g., the computing system 206) based on the transport maintenance mode being associated with the software component 604.

FIG. 9 is a flow chart that illustrates a method 900 for obtaining a support package status of multiple software components in a distributed computing system landscape. For clarity of presentation, the description that follows generally describes method 900 in the context of FIGS. 1 and 2. For example, as illustrated, particular steps of the method 900 may be performed on or at an enterprise system, cloud-based system, and/or on-demand system, while other particular steps may be performed on or at a client system or on-premise system. However, method 900 may be performed, for example, by any other suitable system, environment, software, and hardware, or a combination of systems, environments, software, and hardware as appropriate.

In step 902, for each software sub-component, a transport request is received. Specifically, the software component is associated with one or more software sub-components. The transport request comprises metadata associated with the software sub-component, and a support package start point. For example, for each software component 650a, 650b, 650c, 650d, a transport request is received, including metadata associated with the respective software component 650a, 650b, 650c, 650d, and the support package start point. In step 904, in response to receiving each transport request, a correction transport is created that includes the support package start point and metadata associated with the updated support package. In step 906, each of the correction transports is distributed to a computing system in the distributed computing system landscape. The computing system includes the software sub-components.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order (e.g., FIGS. 3, 4, and 7-9), this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Accordingly, the above description of example implementations does not define or constrain this disclosure. Other changes, substitutions, and alterations are also possible without departing from the spirit and scope of this disclosure.

What is claimed is:

1. A computer-implemented method of obtaining a support package status in a distributed computing system landscape, comprising:
receiving a transport request that comprises metadata associated with a software component, and a support package start point that defines an updated support package status of the software component for receiving an updated support package for the software component;
in response to receiving the transport request, creating a correction transport that comprises the support package start point and metadata associated with the updated support package;
distributing the correction transport, including the support package start point, to a computing system in the distributed computing system landscape, the computing system comprising the software component;
in response to distributing the correction transport, identifying a current support package status of the software component that is executing on the computing system;
comparing the current support package status of the software component with the updated support package status of the support package start point; and
based on the comparison, updating the support package status of the software component.

2. The method of claim 1, wherein creating the correction transport further comprises adding the correction transport to a buffer.

3. The method of claim 2, wherein distributing the correction transport further comprises distributing the correction transport from the buffer to the computing system.

4. The method of claim 1, wherein distributing the correction transport further comprises asynchronously distributing the correction transport to a plurality of computing systems in the distributing computing landscape, each computing system comprising the software component.

5. The method of claim 1, further comprising identifying a maintenance mode associated with the software component, the maintenance mode including a transport maintenance mode and a final maintenance mode, the method further comprising:
distributing the correction transport to the computing system based on the transport maintenance mode being associated with the software component; and
distributing the updated support package to the computing system based on the final maintenance mode being associated with the software component.

6. The method of claim 5, further comprising:
based on the final maintenance mode being associated with the software component, preventing distribution of the correction transport to the computing system; and
based on the transport maintenance mode being associated with the software component, preventing distribution of the updated support package to the computing system.

7. The method of claim 1, wherein the software component is associated with one or more software sub-components, the method further comprising:
receiving, for each software sub-component, a transport request that comprises metadata associated with the software sub-component, and a support package start point;
in response to receiving each transport request, creating a correction transport that comprises the support package start point and metadata associated with the updated support package; and
distributing each of the correction transports to a computing system in the distributed computing system landscape, the computing system comprising the software sub-components.

8. A computer storage medium encoded with a computer program, the program comprising instructions that when executed by one or more computers cause the one or more computers to perform operations comprising:
receiving a transport request that comprises metadata associated with a software component, and a support package start point that defines an updated support package status of the software component for receiving an updated support package for the software component;
in response to receiving the transport request, creating a correction transport that comprises the support package start point and metadata associated with the updated support package;
distributing the correction transport, including the support package start point, to a computing system in the distributed computing system landscape, the computing system comprising the software component;
in response to distributing the correction transport, identifying a current support package status of the software component that is executing on the computing system;
comparing the current support package status of the software component with the updated support package status of the support package start point; and
based on the comparison, updating the support package status of the software component.

9. The computer storage medium of claim 8, wherein creating the correction transport further comprises adding the correction transport to a buffer.

10. The computer storage medium of claim 9, wherein distributing the correction transport further comprises distributing the correction transport from the buffer to the computing system.

11. The computer storage medium of claim 8, wherein distributing the correction transport further comprises asynchronously distributing the correction transport to a plurality of computing systems in the distributing computing landscape, each computing system comprising the software component.

12. The computer storage medium of claim 8, the operations further comprising identifying a maintenance mode associated with the software component, the maintenance mode including a transport maintenance mode and a final maintenance mode, the method further comprising:
distributing the correction transport to the computing system based on the transport maintenance mode being associated with the software component; and
distributing the updated support package to the computing system based on the final maintenance mode being associated with the software component.

13. The computer storage medium of claim 12, the operations further comprising:
based on the final maintenance mode being associated with the software component, preventing distribution of the correction transport to the computing system; and
based on the transport maintenance mode being associated with the software component, preventing distribution of the updated support package to the computing system.

14. The computer storage medium of claim 8, wherein the software component is associated with one or more software sub-components, the operations further comprising:
receiving, for each software sub-component, a transport request that comprises metadata associated with the software sub-component, and a support package start point;
in response to receiving each transport request, creating a correction transport that comprises the support package start point and metadata associated with the updated support package; and
distributing each of the correction transports to a computing system in the distributed computing system landscape, the computing system comprising the software sub-components.

15. A system of one or more computers configured to perform operations comprising:
receiving a transport request that comprises metadata associated with a software component, and a support package start point that defines an updated support package status of the software component for receiving an updated support package for the software component;
in response to receiving the transport request, creating a correction transport that comprises the support package start point and metadata associated with the updated support package;
distributing the correction transport, including the support package start point, to a computing system in the distributed computing system landscape, the computing system comprising the software component;
in response to distributing the correction transport, identifying a current support package status of the software component that is executing on the computing system;
comparing the current support package status of the software component with the updated support package status of the support package start point; and
based on the comparison, updating the support package status of the software component.

16. The system of claim 15, wherein creating the correction transport further comprises adding the correction transport to a buffer.

17. The system of claim 16, wherein distributing the correction transport further comprises distributing the correction transport from the buffer to the computing system.

18. The system of claim 15, wherein distributing the correction transport further comprises asynchronously distributing the correction transport to a plurality of computing systems in the distributing computing landscape, each computing system comprising the software component.

19. The system of claim 15, the operations further comprising identifying a maintenance mode associated with the software component, the maintenance mode including a transport maintenance mode and a final maintenance mode, the method further comprising:
distributing the correction transport to the computing system based on the transport maintenance mode being associated with the software component; and
distributing the updated support package to the computing system based on the final maintenance mode being associated with the software component.

20. The system of claim 19, the operations further comprising:
based on the final maintenance mode being associated with the software component, preventing distribution of the correction transport to the computing system; and
based on the transport maintenance mode being associated with the software component, preventing distribution of the updated support package to the computing system.
